(19) United States
(12) Patent Application Publication
(10) Pub. No.: US 2025/0329916 A1
(43) Pub. Date: Oct. 23, 2025

(54) BASE STATION ANTENNA AND BASE STATION SYSTEM

(71) Applicant: HUAWEI TECHNOLOGIES CO., LTD., Shenzhen (CN)

(72) Inventors: Zijing Du, Xi'an (CN); Yulin Chang, Dongguan (CN); Chen Huang, Dongguan (CN); Yuyang Yuan, Xi'an (CN); Weihong Xiao, Dongguan (CN)

(73) Assignee: HUAWEI TECHNOLOGIES CO., LTD., Shenzhen (CN)

(21) Appl. No.: 19/253,127

(22) Filed: Jun. 27, 2025

Related U.S. Application Data
(63) Continuation of application No. PCT/CN2023/138061, filed on Dec. 12, 2023.

(30) Foreign Application Priority Data
Dec. 28, 2022 (CN) 202211700644.2

(51) Int. Cl. H01Q 1/24; H01Q 1/52; H01Q 19/10

(52) U.S. Cl. CPC H01Q 1/246; H01Q 1/526; H01Q 19/10

(57) ABSTRACT

This application provides a base station antenna and a base station system. The base station antenna includes a reflection panel, a dielectric body, a metal strip, a sliding dielectric, and an antenna element. The reflection panel is provided with a metal cavity, the metal cavity has an opening, and the opening faces a front side of the reflection panel. The metal strip is disposed on the dielectric body, one end of the metal strip is disposed in the metal cavity, and the other end of the metal strip extends out of the metal cavity. At least a part of the sliding dielectric is slidably disposed in the metal cavity. The antenna element is connected to the end of the metal strip that extends out of the metal cavity.

### CROSS-REFERENCE TO RELATED APPLICATIONS

This application is a continuation of International Application No. PCT/CN2023/138061, filed on Dec. 12, 2023, which claims priority to Chinese Patent Application No. 202211700644.2, filed on Dec. 28, 2022. The disclosures of the aforementioned applications are hereby incorporated by reference in their entireties.

### TECHNICAL FIELD

This application relates to the field of communication technologies, and in particular, to a base station antenna and a base station system.

### BACKGROUND

In an existing feeding network of a base station antenna, a coaxial cable is usually used as a feeder, and a discrete phase shifter is used to adjust an input phase of each antenna element to implement beam regulation. However, the existing feeding network is complex and involves many processes during installation, and consequently the labor and time costs associated with installation are high and the product performance consistency is low. In addition, a dielectric loss of the coaxial cable and an insertion loss of the discrete phase shifter are large, causing the overall performance of the antenna to degrade.

### SUMMARY

An objective of this application is to provide an antenna and a base station system, to resolve the foregoing problems that the existing feeding network of a base station antenna is complex during installation, and has the disadvantages of high costs, poor consistency, and large loss.

A first aspect of this application provides an antenna, for example, an antenna for use in a base station, including:
a reflection panel, where the reflection panel is provided with a metal cavity, the metal cavity has an opening, and the opening faces a front side of the reflection panel;
a dielectric body, where one end of the dielectric body is disposed in the metal cavity, and the other end of the dielectric body extends out of the metal cavity;
a metal strip, disposed on the dielectric body, where one end of the metal strip is disposed in the metal cavity, and the other end of the metal strip extends out of the metal cavity;
a sliding dielectric, where at least a part of the sliding dielectric is slidably disposed in the metal cavity; and
an antenna element, where the antenna element is connected to the end that is of the dielectric body and that extends out of the metal cavity, and the antenna element is connected to the end that is of the metal strip and that extends out of the metal cavity.

According to the base station antenna provided in this application, the reflection panel is bent to form a semi-open metal cavity, and the dielectric body, the metal strip, and the sliding dielectric may be disposed in the metal cavity, so that the metal cavity, the dielectric body, the metal strip, and the sliding dielectric can form a feeding network. In addition, the metal cavity may serve as a cavity of a phase shifter, and a part that is of the reflection panel and that is located outside the metal cavity can reflect an electromagnetic wave of the antenna element. In other words, in this application, in a structure in which the metal cavity is formed in the reflection panel, the reflection panel can reflect an electromagnetic wave, and can also serve as a part of the feeding network, thereby improving integration of the base station antenna, and facilitating miniaturization of the base station antenna. In addition, both the feeding network and the antenna element are connected to the reflection panel, so that the structure of the base station antenna is simplified, thereby reducing a dielectric loss and costs.

In a possible design, the base station antenna further includes a metal partition plate, at least a part of the metal partition plate is disposed in the metal cavity so that the metal cavity is partitioned into a first cavity and a second cavity, and a part that is of the metal partition plate and that extends out of the metal cavity is connected to the antenna element.

The metal partition plate may serve as a common ground of the antenna element and the feeding network, and the antenna element and the feeding network do not need to be connected using a conventional welding process, thereby improving integration of the base station antenna, facilitating processing and manufacturing, and reducing costs.

In a possible design, the metal strip includes a first strip and a second strip, at least a part of the first strip is disposed in the first cavity, and at least a part of the second strip is disposed in the second cavity; the dielectric body includes a first dielectric substrate and a second dielectric substrate, at least a part of the first dielectric substrate is disposed in the first cavity, and at least a part of the second dielectric substrate is disposed in the second cavity; the first cavity, the first strip, the first dielectric substrate, and the metal partition plate form a first feeding network, and the second cavity, the second strip, the second dielectric substrate, and the metal partition plate form a second feeding network; and the antenna element includes a first polarization arm and a second polarization arm, the first polarization arm and the second polarization arm are respectively located on two sides of the metal partition plate, the first polarization arm is connected to the first feeding network to form first polarization of the base station antenna, and the second polarization arm is connected to the second feeding network to form second polarization of the base station antenna.

The first cavity, the first strip, the first dielectric substrate, and the metal partition plate form the first feeding network, and the second cavity, the second strip, the second dielectric substrate, and the metal partition plate form the second feeding network. The first feeding network may feed the first polarization arm, and the second feeding network may feed the second polarization arm, so that dual polarization of the base station antenna can be implemented.

In a possible design, the metal partition plate is electrically connected to the bottom of the metal cavity in a welding or coupling manner. The metal partition plate may be directly connected to the bottom of the metal cavity by using a welding process, or may maintain a gap with the bottom of the metal cavity, so that the metal partition plate is coupled to the bottom of the metal cavity without a physical connection. A specific disposition manner of the metal partition plate may be flexibly set based on an actual application case, thereby facilitating an operation.

In a possible design, the base station antenna further includes an electrical connecting piece, a gap is maintained between the metal partition plate and the metal cavity, and the metal partition plate is electrically connected to the reflection panel through the electrical connecting piece.

The electrical connecting piece may be a metal piece with a conductive function, for example, a metal plate, a metal film, or a conductive wire. One end of the electrical connecting piece may be connected to the reflection panel, and the other end may be connected to the metal partition plate. Alternatively, the electrical connecting piece may extend across a side of the opening of the metal cavity, so that two ends of the electrical connecting piece are respectively connected to two sides of the opening of the metal cavity. A middle part of the electrical connecting piece may be directly connected to the metal partition plate. For example, when the electrical connecting piece has a hole, the metal partition plate may include a protrusion, so that the protrusion can be inserted into the hole of the electrical connecting piece and can be in reliable contact with an inner wall of the hole.

In a possible design, the first strip includes a first feeder and a second feeder, one end of the first feeder is connected to the first polarization arm, and the other end of the first feeder is welded or coupled to the second feeder.

The first feeder may be welded to the first polarization arm, and the second feeder may feed the first polarization arm through the first feeder, and may further serve as a part of the feeding network, to implement phase adjustment. The first feeder and the second feeder may be directly connected using a welding process, or may be electrically connected in a coupling manner. Materials of the first feeder and the second feeder may be the same or may be different, for example, may be aluminum or copper.

In a possible design, the second strip includes a third feeder and a fourth feeder, one end of the third feeder is connected to the second polarization arm, and the other end of the fourth feeder is welded or coupled to the third feeder.

In a possible design, the first strip is of an integrally formed structure, and the second strip is of an integrally formed structure. The first strip and the second strip each may be an entire strip, for example, a copper strip or an aluminum strip, to facilitate processing, manufacturing, and assembly.

In a possible design, the sliding dielectric is disposed in at least one of the first cavity and the second cavity.

The sliding dielectric may be disposed only in the first cavity or the second cavity, so that a phase may be adjusted in the first cavity or the second cavity, to implement a dual-polarization antenna. Certainly, alternatively, the sliding dielectric may be disposed in each of the first cavity and the second cavity, so that phases may be separately adjusted in the first cavity and the second cavity, to implement dual polarization.

In a possible design, the metal cavity is formed in the reflection panel by using a bending process, thereby facilitating processing and manufacturing, achieving integration of the reflection panel, and improving structural reliability.

In a possible design, the reflection panel includes a first panel, a second panel, and a third panel, the first panel is provided with the metal cavity, the second panel and the third panel are respectively disposed on two sides of the first panel in a width direction, and the second panel and the third panel are separately coupled to the first panel.

The first panel, the second panel, and the third panel may be separately processed and manufactured, and form the reflection panel in an assembly manner. The first panel may be bent by using a bending process, to form the metal cavity, and the second panel and the third panel may be designed based on a size such as the size of a radiation area of the antenna element, to ensure that the second panel and the third panel have large enough reflective surfaces, to ensure a reflection effect of an electromagnetic wave. The first panel is separately coupled to the second panel and the third panel. This can facilitate installation/detachment between the first panel and the second panel and the third panel, and facilitate separate edge maintenance, and also facilitate separate processing, manufacturing, and transportation management.

In a possible design, a first flange and a second flange are respectively disposed on two sides of the first panel in a width direction of the metal cavity; and the second panel is coupled to the first flange, and the third panel is coupled to the second flange. The first flange and the second flange may provide large connection areas, so that respective coupling effects of the second panel and the third panel with the first flange and the second flange can be ensured.

In a possible design, the base station antenna includes a shielding structure, and the shielding structure is connected to the reflection panel and covers the opening of the metal cavity.

The shielding structure is disposed on one side of the opening of the metal cavity, so that the metal cavity can be shielded by the shielding structure. This can effectively prevent resonance caused by radiation of energy of a high-frequency antenna into the metal cavity. Therefore, through proper disposition of the shielding structure, it can be ensured that both a low-frequency antenna and the high-frequency antenna can normally work.

In a possible design, the shielding structure is a metal plate or a metal film. Therefore, a good shielding effect can be obtained.

In a possible design, the shielding structure is welded, coupled, or connected, through a connecting piece, to the reflection panel. Therefore, reliable connection and fastening between the shielding structure and the reflection panel can be ensured.

In a possible design, the shielding structure is square, rectangular, or grid-shaped. When the shielding structure covers the opening of the metal cavity, an shielding effect preventing an electromagnetic wave from entering the metal cavity can be achieved. The shielding structure may be square or rectangular, to facilitate processing, manufacturing, and assembly. A plurality of shielding structures may be disposed. A gap may exist between some two adjacent shielding structures, to avoid the metal partition plate or another component. Some two adjacent shielding structures may be in direct contact without a gap, to improve a shielding effect.

A second aspect of this application further provides a base station system, including the base station antenna provided in the first aspect of this application.

It should be understood that the foregoing general descriptions and the following detailed descriptions are merely used as an example, and should not limit this application.

### BRIEF DESCRIPTION OF DRAWINGS

FIG. 1 is a diagram of a structure of a base station system according to an embodiment;

FIG. 2 is an internal block diagram of a base station antenna according to an embodiment;

FIG. 3 is a diagram of a structure of a base station antenna according to an embodiment in of this application;

FIG. 4 is a side view of a base station antenna according to an embodiment of this application;

FIG. 5 is a diagram of a structure of a base station antenna according to another embodiment of this application;

FIG. 6 is an enlarged view of a position A in FIG. 5;

FIG. 7 is a side view of a base station antenna according to another embodiment of this application;

FIG. 8 is another side view of a base station antenna according to another embodiment of this application;

FIG. 9 is a diagram of a structure of a base station antenna according to still another embodiment of this application;

FIG. 10 is an enlarged view of a position B in FIG. 9;

FIG. 11 is a side view of a base station antenna according to still another embodiment of this application;

FIG. 12 is a diagram of a structure of a base station antenna according to yet another embodiment of this application;

FIG. 13 is an enlarged view of a position C in FIG. 12; and

FIG. 14 is a side view of a base station antenna according to yet another embodiment of this application.

### REFERENCE NUMERALS

```
100-base station antenna;
101-antenna element array;
102-feeding network;
103-phase shifter;
104-transmission network;
105-combiner;
106-antenna joint;
107-radome;
200-antenna adjustment support;
300-dead lever;
400-joint sealing piece;
500-grounding device;
    1-reflection panel;
  11-metal cavity;
111-first cavity;
112-second cavity;
113-opening;
  12-first panel;
121-first flange;
122-second flange;
  13-second panel;
  14-third panel;
    2-dielectric body;
  21-first dielectric substrate;
211-first segment;
212-second segment;
  22-second dielectric substrate;
    3-metal strip;
  31-first strip;
311-first feeder;
312-second feeder;
  32-second strip;
321-third feeder;
322-fourth feeder;
    4-sliding dielectric;
    5-antenna element;
  51-first polarization arm;
  52-second polarization arm;
    6-metal partition plate;
    7-electrical connecting piece; and
    8-shielding structure.
```

The accompanying drawings herein are incorporated into the specification and form a part of the specification, show embodiments in accordance with this application, and are used together with the specification to explain the principles of this application.

### DESCRIPTION OF EMBODIMENTS

To better understand technical solutions of this application, the following describes embodiments of this application in detail with reference to the accompanying drawings. It should be understood that the specific embodiments described herein are merely used to explain this application but are not intended to limit this application.

In descriptions of this application, unless otherwise specified and limited, the terms “first” and “second” are merely intended for a purpose of description, and cannot be understood as an indication or implication of relative importance. Unless otherwise specified or stated, the term “a plurality of” means two or more than two. The terms “connection”, “fastening”, and the like all should be understood in a broad sense. For example, “connection” may be a fastened connection, or may be a detachable connection, an integrated connection, or an electrical connection; or may be a direct connection, or may be an indirect connection through an intermediate medium. A person of ordinary skill in the art may understand specific meanings of the foregoing terms in this application based on a specific case.

In an existing feeding network of a base station antenna, usually, a coaxial cable is used as a feeder, and a discrete phase shifter is used to adjust an input phase of each antenna element to implement beam regulation. A feeding network is electrically connected to the antenna element in a welding manner. An existing implementation solution in the industry is complex in installation and involves many processes, consequently increasing labor and time costs and reducing product performance consistency. In addition, a dielectric loss of the coaxial cable is large, and consequently an overall gain of the base station antenna is small. In addition, the feeding network and the antenna elements use discrete architecture, consequently hindering overall integration and increasing labor and time costs and dielectric loss. Therefore, it is of great significance to study and design a communication antenna system characterized by high integration, simplicity, low loss, and low costs.

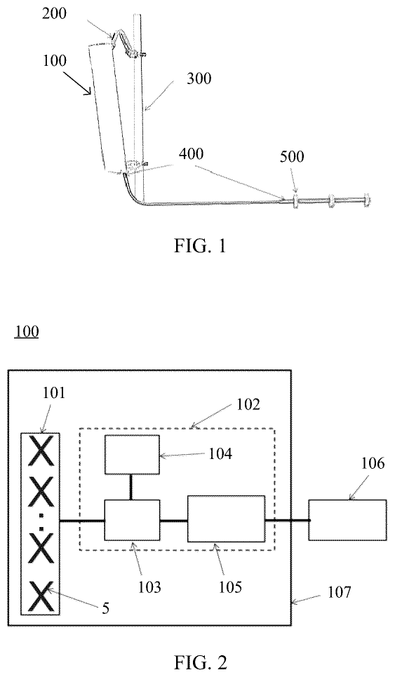

Embodiments of this application provide an antenna that is suitable for use in a base station and other devices or systems. The below descriptions use a base station antenna as an example. The base station antenna can be used in a base station system. The base station system and the base station antenna may be used in radar, broadcast, communication, and other fields. FIG. 1 is a diagram of a structure of a base station system according to an embodiment. Referring to FIG. 1, the base station system includes a base station antenna 100, an antenna adjustment support 200, a dead lever 300, a joint sealing piece 400, a grounding device 500, and the like. The base station system is an interface device for wireless communication, and can exchange information with a communication terminal in a region in which the base station system is located.

FIG. 2 is an internal block diagram of a base station antenna 100 according to an embodiment. Referring to FIG. 2, the base station antenna 100 includes an antenna element array 101, a phase shifter 103, a transmission network 104 or a calibration network, a combiner 105 or a fluctuator, and a radome 107. The antenna element array includes a plurality of antenna elements 5, and the antenna element array 101 receives or transmits a radio frequency signal through a feeding network 102 including the phase shifter 103, the transmission network 104, and the combiner 105. The feeding network 102 can feed a radio frequency signal to the antenna element array 101 based on a specific amplitude and phase, or send a radio signal received by the antenna element array 101 to a signal processing unit of a base station system through an antenna joint 106 based on a specific amplitude and phase. The radome 107 may protect internal components from electromagnetic interference in an external environment, or damages from an external foreign object, or other risks.

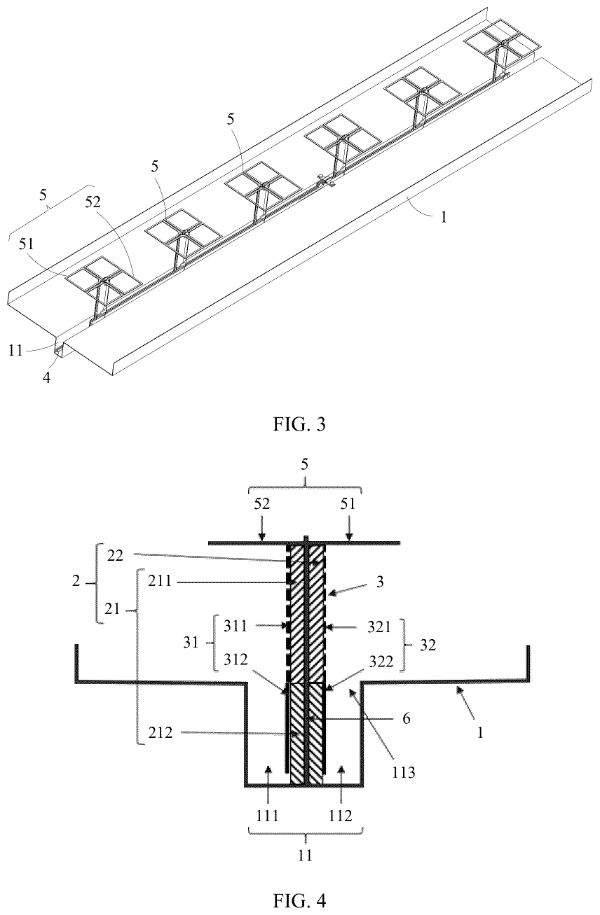

Specifically, FIG. 3 is a diagram of a structure of a base station antenna according to an embodiment of this application, and FIG. 4 is a side view of a base station antenna according to an embodiment of this application. Referring to FIG. 3 and FIG. 4, a base station antenna 100 includes a reflection panel 1, a dielectric body 2, a metal strip 3, a sliding dielectric 4, and an antenna element 5.

The reflection panel 1 is a metal sheet piece, and can reflect an electromagnetic wave of the antenna element 5. Therefore, receiver sensitivity of antenna signals can be improved, and the antenna signals can be gathered at a receiving point through reflection. This greatly enhances a receiving/transmitting capability of the antenna, and also blocks and shields interference of another wave from a back direction (an opposite direction) with a received signal.

The antenna element 5 is an apparatus for receiving/sending an electromagnetic wave in the antenna. In some cases, “antenna” is a radiator in a narrow sense. The radiator converts guided wave energy from a transmitter into a radio wave, or converts a radio wave into guided wave energy, to radiate and receive a radio wave. Modulated high-frequency current energy (or guided wave energy) generated by the transmitter is transmitted to a transmit antenna element 5 through a feeder. The antenna element 5 converts the modulated high-frequency current energy into specific polarized electromagnetic wave energy and radiates the polarized electromagnetic wave energy in a required direction. A receive antenna element 5 converts specific polarized electromagnetic wave energy from a specific direction of space into modulated high-frequency current energy, and transmits the modulated high-frequency current energy to an input end of a receiver through a feeder.

In some embodiments, the antenna element 5 is located on a front side of the reflection panel 1, and has a specific distance from the reflection panel 1, so that an electromagnetic wave radiated by the antenna element 5 toward the reflection panel 1 can be reflected by the reflection panel 1, and energy radiated by the antenna element 5 toward a side away from the reflection panel 1 is enhanced.

The dielectric body 2 may be a flame-resistant material (FR-4) dielectric board, may be a Rogers dielectric board, or may be a hybrid dielectric board of Rogers and FR-4, or the like. Herein, FR-4 is a grade designation of a flame-resistant material, and the Rogers dielectric board is a high-frequency board.

The sliding dielectric 4 may be an insulating dielectric with a high and stable dielectric constant. When the sliding dielectric 4 slides, different ports may obtain phase changes at specified proportions.

In some embodiments, in referring to FIG. 4, a metal cavity 11 is disposed in the reflection panel 1, the metal cavity 11 has an opening 113, the opening 113 faces the front side of the reflection panel 1, and the front of the reflection panel 1 is a surface of a side on which the antenna element 5 is located.

The reflection panel 1 is a metal plate made of a metal material, so that the reflection panel 1 can be bent to form the metal cavity 11. The opening 113 of the metal cavity 11 faces the side on which the antenna element 5 is located, so that the metal cavity 11 forms a semi-open cavity structure. The dielectric body 2, the metal strip 3, and the sliding dielectric 4 may be disposed in the metal cavity 11, so that the metal cavity 11, the dielectric body 2, the metal strip 3, and the sliding dielectric 4 can form a feeding network. In addition, the metal cavity 11 may serve as a cavity of a phase shifter, and a part that is of the reflection panel 1 and that is located outside the metal cavity 11 can reflect an electromagnetic wave of the antenna element 5. In other words, in an embodiment, in a structure in which the metal cavity 11 is formed in the reflection panel 1, the reflection panel 1 can reflect an electromagnetic wave, and can also serve as a part of the feeding network, thereby improving integration of the base station antenna, and facilitating miniaturization of the base station antenna. In addition, both the feeding network and the antenna element 5 are connected to the reflection panel 1, so that a structure of the base station antenna is simplified, thereby reducing a dielectric loss and costs.

Specifically, a height of the dielectric body 2 is greater than a depth of the metal cavity 11, so that one end of the dielectric body 2 is disposed in the metal cavity 11, and the other end of the dielectric body 2 extends out of the metal cavity 11. The antenna element 5 can be connected to the end that is of the dielectric body 2 and that extends out of the metal cavity 11. A specific spacing may be maintained between the antenna element 5 and the reflection panel 1 through the dielectric body 2. This facilitates reflection of an electromagnetic wave. The metal strip 3 is disposed on the dielectric body 2, one end of the metal strip 3 is disposed in the metal cavity 11, and the other end of the metal strip 3 extends out of the metal cavity 11. The metal strip 3 may feed the antenna element 5, and a part that is of the metal strip 3 and that is located in the metal cavity 11 may cooperate with the sliding dielectric 4 to implement phase adjustment.

In one embodiment, in referring to FIG. 3, a plurality of antenna elements 5 may be disposed, and the plurality of antenna elements 5 are evenly arranged on the reflection panel 1 in a linear shape, to form an antenna array.

As a specific implementation, the reflection panel 1 may be bent by using a bending process, to form the metal cavity 11. It may be understood that the reflection panel 1 may be a metal plate, for example, an aluminum plate. A flat metal plate may be bent to a specified shape by using a sheet metal bending process. In one embodiment, the reflection panel 1 can be directly bent to form the metal cavity 11, thereby facilitating processing and manufacturing, implementing integration of the reflection panel 1, and improving structural reliability.

As a specific implementation, in referring to FIG. 4, the base station antenna further includes a metal partition plate 6, and at least a part of the metal partition plate 6 is disposed in the metal cavity 11 so that the metal cavity 11 is partitioned into a first cavity 111 and a second cavity 112. The metal partition plate 6 may be disposed at a middle position of the metal cavity 11 in a width direction of the metal cavity 11, so that the first cavity 111 and the second cavity 112 that are obtained through partitioning form a symmetric structure, to implement dual polarization.

A conventional antenna unit and a conventional feeding network are separate components, and need to be separately processed and manufactured, and then a feeding point of the antenna unit needs to be connected to a feeding port of the feeding network by using a welding process or the like. This is a complex assembling process and difficult to maintain consistency. In one embodiment, the metal partition plate 6 is of an integral structure. The part that is of the metal partition plate 6 and that is located in the metal cavity 11 may serve as a part of the feeding network, and a part that is of the metal partition plate 6 and that extends out of the metal cavity 11 may be connected to the antenna element 5. Therefore, the metal partition plate 6 may serve as a common ground of the antenna element 5 and the feeding network, and the antenna element 5 and the feeding network do not need to be connected by using a conventional welding process, thereby improving integration of the base station antenna, facilitating processing and manufacturing, and reducing costs.

Referring to FIG. 4, the antenna element 5 includes a first polarization arm 51 and a second polarization arm 52, the first polarization arm 51 and the second polarization arm 52 are respectively located on two sides of the metal partition plate 6 in a width direction, the first polarization arm 51 is connected to a first feeding network to form first polarization of the base station antenna, and the second polarization arm 52 is connected to a second feeding network to form second polarization of the base station antenna, so that a dual-polarized antenna can be constructed.

Referring to FIG. 4, the metal strip 3 includes a first strip 31 and a second strip 32, at least a part of the first strip 31 is disposed in the first cavity 111, and at least a part of the second strip 32 is disposed in the second cavity 112. The dielectric body 2 includes a first dielectric substrate 21 and a second dielectric substrate 22, at least a part of the first dielectric substrate 21 is disposed in the first cavity 111, and at least a part of the second dielectric substrate 22 is disposed in the second cavity 112. The first cavity 111, the first strip 31, the first dielectric substrate 21, and the metal partition plate 6 form the first feeding network, and the second cavity 112, the second strip 32, the second dielectric substrate 22, and the metal partition plate 6 form the second feeding network. The first feeding network may feed the first polarization arm 51, and the second feeding network may feed the second polarization arm 52, so that dual polarization of the base station antenna can be implemented.

Therefore, in some embodiments, two feeding networks can be formed in the metal cavity 11 by using only one metal partition plate 6, to respectively feed the first polarization arm 51 and the second polarization arm 52 of the antenna element 5, so that dual polarization of the antenna can be implemented. Therefore, the structure is simple, and so are the assembly and manufacturing processes. Integration is also high.

For ease of processing and manufacturing, the first dielectric substrate 21 and the second dielectric substrate 22 each may be of an integrally formed structure. Certainly, in some other embodiments, in referring to FIG. 4, the first dielectric substrate 21 may include a first segment 211 and a second segment 212. The first segment 211 is disposed in the metal cavity 11 to serve as a part of the feeding network. The second segment 212 is disposed outside the metal cavity 11, to be connected to the antenna element 5. The first segment 211 and the second segment 212 may be connected through direct contact, or may form a coupling structure without mutual contact, to facilitate separate installation/detachment and maintenance of the first segment 211 or the second segment 212. The second dielectric substrate 22 may have a same structure and a same disposition manner as the first dielectric substrate 21. Details are not described again.

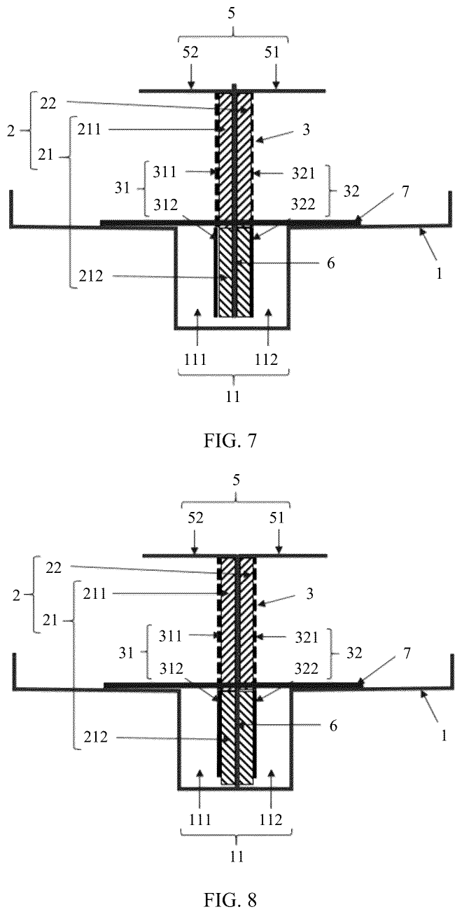

As a specific implementation, the metal partition plate 6 is electrically connected to the bottom of the metal cavity 11 in a welding or coupling manner. To be specific, in referring to FIG. 4, the metal partition plate 6 may be directly connected to the bottom of the metal cavity 11 by using a welding process, and in referring to FIG. 7, alternatively, the metal partition plate 6 may maintain a gap with the bottom of the metal cavity 11, so that the metal partition plate 6 is coupled to the bottom of the metal cavity 11 without a physical connection. A specific disposition manner of the metal partition plate 6 may be flexibly set based on an actual application case, thereby facilitating an operation.

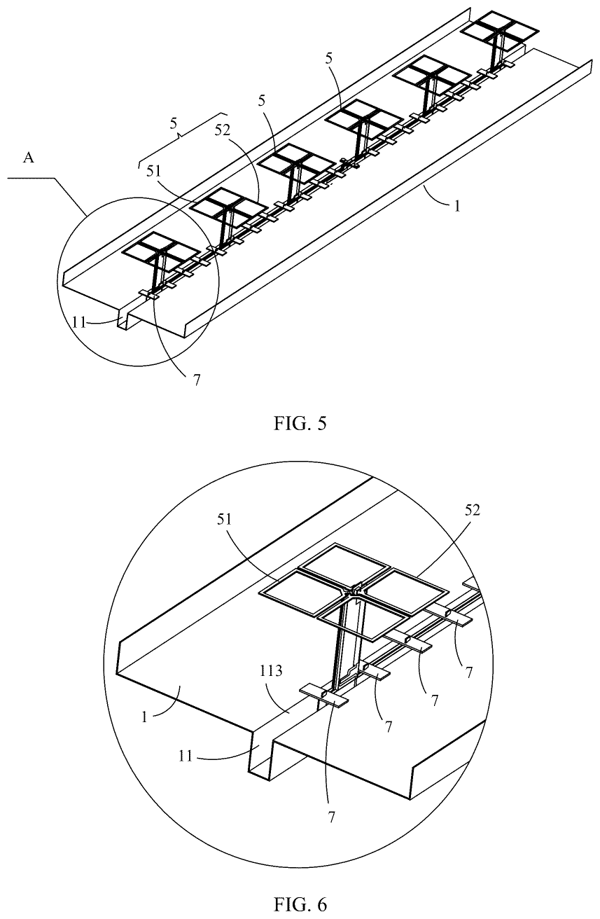

In some other embodiments, FIG. 5 is a diagram of a structure of a base station antenna according to another embodiment of this application, FIG. 6 is an enlarged view of a position A in FIG. 5, and FIG. 7 is a side view of a base station antenna according to another embodiment of this application. In referring to FIG. 5 to FIG. 7, the base station antenna further includes an electrical connecting piece 7, a gap is maintained between the metal partition plate 6 and the metal cavity 11, and the metal partition plate 6 is electrically connected to the reflection panel 1 through the electrical connecting piece 7.

The electrical connecting piece 7 may be a metal piece with a conductive function, for example, a metal plate, a metal film, or a conductive wire. One end of the electrical connecting piece 7 may be connected to the reflection panel 1, and the other end may be connected to the metal partition plate 6. In referring to FIG. 7, alternatively, the electrical connecting piece 7 may extend across a side of the opening 113 of the metal cavity 11, so that two ends of the electrical connecting piece 7 are respectively connected to two sides of the opening 113 of the metal cavity 11. A middle part of the electrical connecting piece 7 may be directly connected to the metal partition plate 6. For example, when the electrical connecting piece 7 has a hole, the metal partition plate 6 may be configured with a protrusion, so that the protrusion can be inserted into the hole of the electrical connecting piece 7 and can be in reliable contact with an inner wall of the hole.

In addition, FIG. 8 is another side view of a base station antenna according to another embodiment of this application. In referring to FIG. 8, alternatively, the bottom of the metal partition plate 6 may be in direct contact with the bottom of the metal cavity 11, and the metal partition plate 6 may be further electrically connected to the reflection panel 1 through the electrical connecting piece 7, so that grounding reliability of the metal partition plate 6 can be ensured.

As a specific implementation, in referring to FIG. 4, the first strip 31 includes a first feeder 311 and a second feeder 312, one end of the first feeder 311 is connected to the first polarization arm 51, and the other end of the first feeder 311 is welded or coupled to the second feeder 312.

The first feeder 311 may be welded to the first polarization arm 51, and the second feeder 312 may feed the first polarization arm 51 through the first feeder 311, and may further serve as a part of the feeding network, to implement phase adjustment. The first feeder 311 and the second feeder 312 may be directly connected using a welding process, or may be electrically connected in a coupling manner. Materials of the first feeder 311 and the second feeder 312 may be the same or may be different, for example, may be aluminum or copper.

Certainly, for ease of processing, manufacturing, and installation, the first feeder 311 and the second feeder 312 may be of an integral structure. To be specific, the first feeder 311 and the second feeder 312 are respectively two parts of the first strip 31, the first feeder 311 is a part that is of the first strip 31 and that extends out of the metal cavity 11, and the second feeder 312 is a part that is of the first strip 31 and that is located in the metal cavity 11.

Similarly, the second strip 32 includes a third feeder 321 and a fourth feeder 322, one end of the third feeder 321 is connected to the second polarization arm 52, and the other end of the fourth feeder 322 is welded or coupled to the third feeder 321. A connection relationship and functions of the third feeder 321 and the fourth feeder 322 are consistent with those of the first feeder 311 and the second feeder 312. Details are not described herein.

As a specific implementation, the first strip 31 is an integrally formed structure, and the second strip 32 is an integrally formed structure. The first strip 31 and the second strip 32 each may be an entire strip, for example, a copper strip or an aluminum strip, to facilitate processing, manufacturing, and assembly.

As a specific implementation, the sliding dielectric 4 is disposed in at least one of the first cavity 111 and the second cavity 112. For example, the sliding dielectric 4 may be disposed only in the first cavity 111 or the second cavity 112, so that a phase may be adjusted in the first cavity 111 or the second cavity 112, to implement a dual-polarized antenna. Alternatively, the sliding dielectric 4 may be disposed in each of the first cavity 111 and the second cavity 112, so that phases may be separately adjusted in the first cavity 111 and the second cavity 112, to implement dual polarization. The sliding dielectric 4 may be controlled, through a structural piece such as a pull rod, to move.

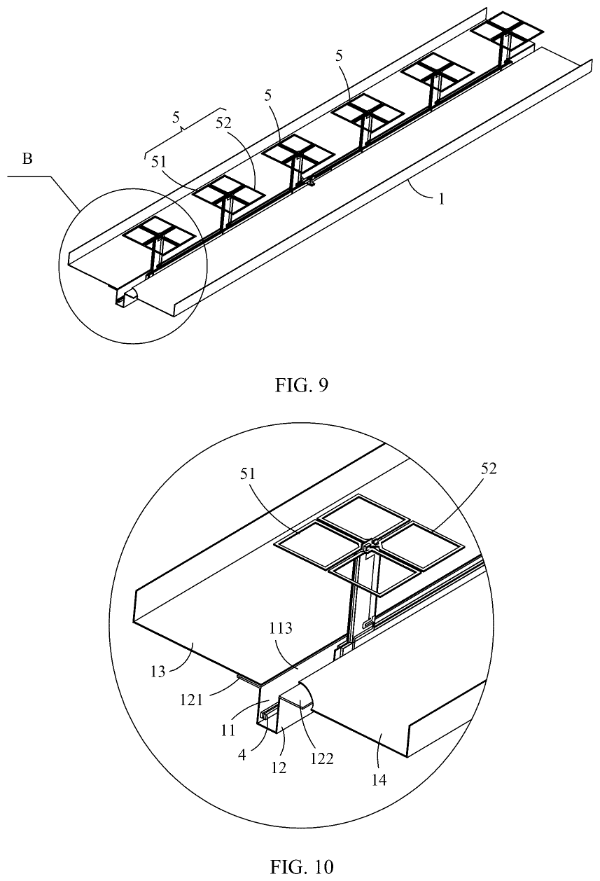

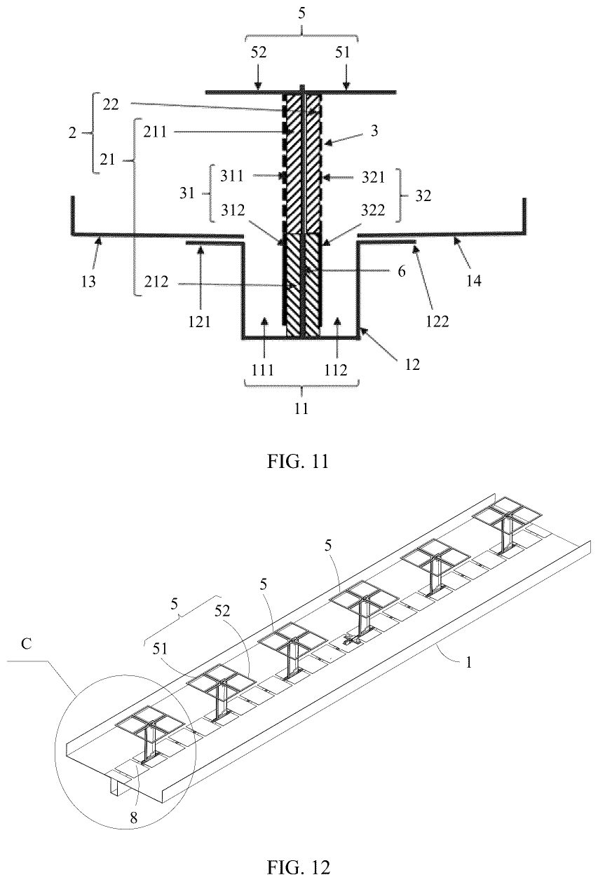

As a specific implementation, FIG. 9 is a diagram of a structure of a base station antenna according to still another embodiment of this application, FIG. 10 is an enlarged view of a position B in FIG. 9, and FIG. 11 is a side view of a base station antenna according to still another embodiment of this application. In referring to FIG. 9 to FIG. 11, the reflection panel 1 includes a first panel 12, a second panel 13, and a third panel 14, the metal cavity 11 is disposed in the first panel 12, the second panel 13 and the third panel 14 are respectively disposed on two sides of the first panel 12 in a width direction, and the second panel 13 and the third panel 14 are separately coupled to the first panel 12. Through the coupling, a specific gap may be maintained between each of the second panel 13 and the third panel 14 and the first panel 12. In this embodiment, the first panel 12, the second panel 13, and the third panel 14 may be separately processed and manufactured, and form the reflection panel 1 in an assembly manner. The first panel 12 may be bent by using a bending process, to form the metal cavity 11, and the second panel 13 and the third panel 14 may be designed based on a size such as a radiation area of the antenna element 5, to ensure that the second panel 13 and the third panel 14 have large enough reflective surfaces, to ensure a reflection effect of an electromagnetic wave. The first panel 12 is separately coupled to the second panel 13 and the third panel 14. This can facilitate installation/detachment between the first panel 12 and the second panel 13 and the third panel 14, and separate edge maintenance, and also facilitate separate processing, manufacturing, and transportation management.

In addition, in some other embodiments, the first panel 12 may be separately directly connected to the second panel 13 and the third panel 14 by using a welding process or the like. This is not limited in this embodiment.

Specifically, in referring to FIG. 11, a first flange 121 and a second flange 122 are respectively disposed on two sides of the first panel 12 in the width direction of the metal cavity 11. The second panel 13 is coupled to the first flange 121, and the third panel 14 is coupled to the second flange 122. The first flange 121 and the second flange 122 may provide large connection areas, so that respective coupling effects of the second panel 13 and the third panel 14 with the first flange 121 and the second flange 122 can be ensured. The second panel 13 and the third panel 14 may be connected to the first panel 12 through insulating supports.

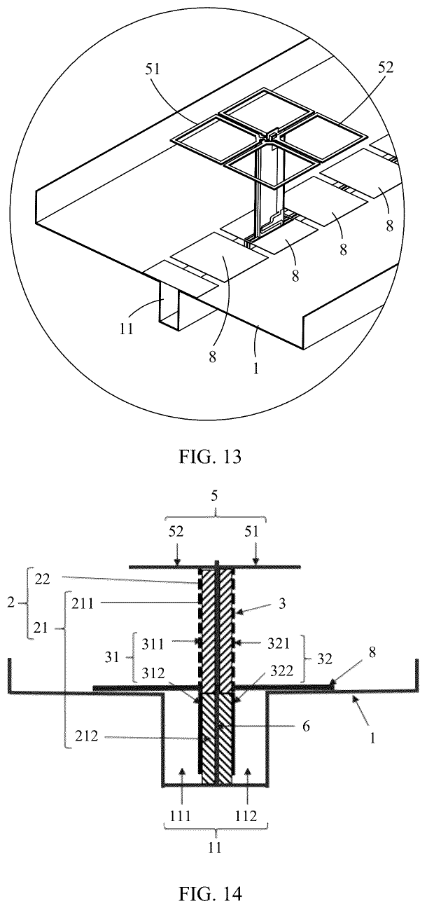

As a specific implementation, FIG. 12 is a diagram of a structure of a base station antenna according to yet another embodiment of this application, FIG. 13 is an enlarged view of a position C in FIG. 12, and FIG. 14 is a side view of a base station antenna according to yet another embodiment of this application. In referring to FIG. 12 to FIG. 14, the base station antenna includes a shielding structure 8, and the shielding structure 8 is connected to the reflection panel 1 and covers the opening 113 of the metal cavity 11.

The antenna element 5 and the feeding network may form a high-frequency antenna or a low-frequency antenna. The two types of antennas have different operating frequency bands, and a structure of the metal cavity 11 brings different impact on the two types of antennas. For example, if the metal cavity 11 is deep, the low-frequency antenna can normally work. However, for the high-frequency antenna, an excessively deep metal cavity 11 causes the high-frequency antenna to cause resonance, and therefore radiation performance of the high-frequency antenna is reduced. Therefore, in some embodiments, the shielding structure 8 is disposed on one side of the opening 113 of the metal cavity 11, so that the metal cavity 11 can be shielded by using the shielding structure 8. This can effectively prevent resonance in the metal cavity 11 caused by radiation of energy of the high-frequency antenna. Therefore, through proper disposition of the shielding structure 8, it can be ensured that both the low-frequency antenna and the high-frequency antenna can normally work.

The shielding structure 8 is a metal plate or a metal film. For example, the shielding structure 8 is a copper plate or an aluminum plate. The shielding structure 8 can cover the opening 113 of the metal cavity 11, and is connected and fastened to the reflection panel 1 by using a welding process, a riveting process, or the like. Therefore, a good shielding effect can be obtained. The shielding structure 8 may alternatively be a metal film, and the metal film may be bonded and fastened to the reflection panel 1 by using a bonding process.

As a specific implementation, the shielding structure 8 is welded, coupled, or connected, through a connecting piece, to the reflection panel 1, so that reliability of connection and fastening between the shielding structure 8 and the reflection panel 1 can be ensured. When the connecting piece is used for connection, the connecting piece may be a screw, a pin, or the like. This can facilitate installation/detachment of the shielding structure 8 while ensuring reliability of connection and fastening between the shielding structure 8 and the reflection panel 1.

As a specific implementation, the shielding structure 8 may be but is not limited to being square, rectangular, or grid-shaped, or may be in another regular or irregular shape. When the shielding structure 8 covers the opening 113 of the metal cavity 11, a shielding effect that prevents an electromagnetic wave from entering the metal cavity 11 can be achieved. In some embodiments, the shielding structure 8 may be square or rectangular, to facilitate processing, manufacturing, and assembly. A plurality of shielding structures 8 may be disposed. A gap may exist between some two adjacent shielding structures 8, to avoid the metal partition plate 6 or another component. Some two adjacent shielding structures 8 may be in direct contact without a gap, to improve a shielding effect.

The foregoing descriptions are merely embodiments of this application, and are not intended to limit this application. For a person skilled in the art, this application may have various modifications and variations. Any modification, equivalent replacement, improvement, or the like made without departing from the spirit and principle of this application shall fall within the protection scope of this application.

What is claimed is:

1. A antenna, comprising:
a reflection panel, wherein the reflection panel is provided with a metal cavity, the metal cavity has an opening, and the opening faces a front side of the reflection panel;
a dielectric body, wherein one end of the dielectric body is disposed in the metal cavity, and another end of the dielectric body extends out of the metal cavity;
a metal strip, disposed on the dielectric body, wherein one end of the metal strip is disposed in the metal cavity, and another end of the metal strip extends out of the metal cavity;
a sliding dielectric, wherein at least a part of the sliding dielectric is slidably disposed in the metal cavity; and
an antenna element, wherein the antenna element is connected to the end that is of the dielectric body and that extends out of the metal cavity, and the antenna element is connected to the end that is of the metal strip and that extends out of the metal cavity.

2. The antenna according to claim 1, wherein the antenna further comprises a metal partition plate, at least a part of the metal partition plate is disposed in the metal cavity so that the metal cavity is partitioned into a first cavity and a second cavity, and a part that is of the metal partition plate and that extends out of the metal cavity is connected to the antenna element.

3. The antenna according to claim 2, wherein the metal strip comprises a first strip and a second strip, at least a part of the first strip is disposed in the first cavity, and at least a part of the second strip is disposed in the second cavity;
the dielectric body comprises a first dielectric substrate and a second dielectric substrate, at least a part of the first dielectric substrate is disposed in the first cavity, and at least a part of the second dielectric substrate is disposed in the second cavity;
the first cavity, the first strip, the first dielectric substrate, and the metal partition plate form a first feeding network, and the second cavity, the second strip, the second dielectric substrate, and the metal partition plate form a second feeding network; and
the antenna element comprises a first polarization arm and a second polarization arm, the first polarization arm and the second polarization arm are respectively located on two sides of the metal partition plate, the first polarization arm is connected to the first feeding network to form first polarization of the antenna, and the second polarization arm is connected to the second feeding network to form second polarization of the antenna.

4. The antenna according to claim 2, wherein the metal partition plate is electrically connected to the bottom of the metal cavity in a welding or coupling manner.

5. The antenna according to claim 2, wherein the antenna further comprises an electrical connecting piece, a gap is maintained between the metal partition plate and the metal cavity, and the metal partition plate is electrically connected to the reflection panel through the electrical connecting piece.

6. The antenna according to claim 3, wherein the first strip comprises a first feeder and a second feeder, one end of the first feeder is connected to the first polarization arm, and the other end of the first feeder is welded or coupled to the second feeder; and
wherein the second strip comprises a third feeder and a fourth feeder, one end of the third feeder is connected to the second polarization arm, and the other end of the third feeder is welded or coupled to the fourth feeder.

7. The antenna according to claim 2, wherein the sliding dielectric is disposed in at least one of the first cavity or the second cavity.

8. The antenna according to claim 1, wherein the metal cavity is formed in the reflection panel by using a bending process.

9. The antenna according to claim 1, wherein the reflection panel comprises a first panel, a second panel, and a third panel, the first panel is provided with the metal cavity, the second panel and the third panel are respectively disposed on two sides of the first panel in a width direction, and the second panel and the third panel are separately coupled to the first panel.

10. The antenna according to claim 9, wherein a first flange and a second flange are respectively disposed on two sides of the first panel in a width direction of the metal cavity; and
the second panel is coupled to the first flange, and the third panel is coupled to the second flange.

11. The antenna according to claim 1, wherein the antenna comprises a shielding structure, and the shielding structure is welded, coupled, or connected to the reflection panel and covers the opening of the metal cavity.

12. The antenna according to claim 11, wherein the shielding structure is a metal plate or a metal film.

13. The antenna according to claim 11, wherein the shielding structure is square, rectangular, or grid-shaped.

14. A base station system, comprising one or more processing circuits and a base station antenna, wherein the base station antenna comprises:
a reflection panel, wherein the reflection panel is provided with a metal cavity, the metal cavity has an opening, and the opening faces a front side of the reflection panel;
a dielectric body, wherein one end of the dielectric body is disposed in the metal cavity, and the other end of the dielectric body extends out of the metal cavity;
a metal strip, disposed on the dielectric body, wherein one end of the metal strip is disposed in the metal cavity, and the other end of the metal strip extends out of the metal cavity;
a sliding dielectric, wherein at least a part of the sliding dielectric is slidably disposed in the metal cavity; and
an antenna element, wherein the antenna element is connected to the end that is of the dielectric body and that extends out of the metal cavity, and the antenna element is connected to the end that is of the metal strip and that extends out of the metal cavity.

15. The base station system according to claim 14, wherein the base station antenna further comprises a metal partition plate, at least a part of the metal partition plate is disposed in the metal cavity so that the metal cavity is partitioned into a first cavity and a second cavity, and a part that is of the metal partition plate and that extends out of the metal cavity is connected to the antenna element.

16. The base station system according to claim 15, wherein the metal strip comprises a first strip and a second strip, at least a part of the first strip is disposed in the first cavity, and at least a part of the second strip is disposed in the second cavity;
the dielectric body comprises a first dielectric substrate and a second dielectric substrate, at least a part of the first dielectric substrate is disposed in the first cavity, and at least a part of the second dielectric substrate is disposed in the second cavity;
the first cavity, the first strip, the first dielectric substrate, and the metal partition plate form a first feeding network, and the second cavity, the second strip, the second dielectric substrate, and the metal partition plate form a second feeding network; and
the antenna element comprises a first polarization arm and a second polarization arm, the first polarization arm and the second polarization arm are respectively located on two sides of the metal partition plate, the first polarization arm is connected to the first feeding network to form first polarization of the base station antenna, and the second polarization arm is connected to the second feeding network to form second polarization of the base station antenna.

17. The base station system according to claim 15, wherein the metal partition plate is electrically connected to the bottom of the metal cavity in a welding or coupling manner.

18. The base station system according to claim 15, wherein the base station antenna further comprises an electrical connecting piece, a gap is maintained between the metal partition plate and the metal cavity, and the metal partition plate is electrically connected to the reflection panel through the electrical connecting piece.

19. The base station system according to claim 16, wherein the first strip comprises a first feeder and a second feeder, one end of the first feeder is connected to the first polarization arm, and the other end of the first feeder is welded or coupled to the second feeder; and
wherein the second strip comprises a third feeder and a fourth feeder, one end of the third feeder is connected to the second polarization arm, and the other end of the third feeder is welded or coupled to the fourth feeder.

20. The base station system according to claim 14, wherein the reflection panel comprises a first panel, a second panel, and a third panel, the first panel is provided with the metal cavity, the second panel and the third panel are respectively disposed on two sides of the first panel in a width direction, and the second panel and the third panel are separately coupled to the first panel.
